(19) United States
(12) Patent Application Publication
(10) Pub. No.: US 2004/0191057 A1
(43) Pub. Date: Sep. 30, 2004

(54) [COOLING FAN WITH DUST-FILTERING FUNCTION]

(76) Inventors: Nick Lee, Taipei (TW); Arthur Shen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,859

(22) Filed: Aug. 22, 2003

(30) Foreign Application Priority Data
Mar. 12, 2003 (TW) 92203767

(51) Int. Cl. F03B 3/12

(52) U.S. Cl. 415/121.1

(57) ABSTRACT

A cooling fan with dust-filtering function is provided. The cooling fan at least comprises a fan base, a fan module, a filter frame and a filtering unit. The fan bas has an air inlet and an air outlet. The fan module is set up within the fan base. The filter frame is detachably attached to the fan base and the filtering unit is set up within the filter frame such that the filtering unit covers the air inlet. A user is free to remove the filter frame along with the filtering unit for a cleanup and assemble the filter frame onto the fan base thereafter. Hence, the filtering unit can be cleaned and reused to provide the cooling fan with a constant cooling capacity and a longer working life.

### CROSS REFERENCE TO RELATED APPLICATIONS

This application claims the priority benefit of Taiwan application serial no. 92203767, filed Mar. 12, 2003.

### BACKGROUND OF INVENTION

1. Field of Invention

The present invention relates to a cooling fan. More particularly, the present invention relates to a cooling fan with dust-filtering function.

2. Description of Related Art

Due to the rapid progress in computer technologies in recent years, computers now operates at a higher speed resulting in the generation of considerably heat by the electronic devices. To prevent temporary or permanent damage to the internal devices due to the buildup of excessive heat, the computer must have an efficient cooling system. In general, aside from a main cooling fan set up to cool the host computer, additional cooling devices are also set up to cool down the major heat-producing device such as the power supply, the central processing unit (CPU), the graphic processor unit (GPU) and the chipset.

At present, the most efficient and commonly used cooling devices include the heat sink and the cooling fan. The heat sink is a device comprising a cooling plate and a number of closely spaced fins protruding from the cooling plate. Hence, when the cooling plate is directly attached to the surface of an electronic unit, heat generated by the electronic unit is easily channel to the surface of the cooling plate (including the cooling plate and the cooling fins) through thermal conduction. Thereafter, heat on the surface of the cooling plate is dissipated to surrounding atmosphere through thermal convection. In other words, the heat generated by the electronic unit is carried away via thermal conduction and convection. To increase the heat-dissipating capacity even further, an additional cooling fan may be mounted on top or around the heat sink. When the cooling fan is properly aligned with layout of the cooling fins, the airflow produced by the cooling fan can sweep over the space between the fins and carry away the heat by forced convection. Therefore, the performance of the cooling device via thermal convection may significantly improve.

In general, the reason a cooling fan stops rotating or drops in performance is the accumulation of cottony dust suspended in the air on the oily shaft. Cottony impurities are easily attracted to oily lubricant on the axle of the fan. However, if the axle of the cooling fan spins without the lubricant, working life of the cooling fan will be shortened. Although a few conventional designs has a filter installed at the air inlet position for filtering away suspended cottony dust particles, the filter will accumulate so much cottony dust after a while that a fraction of the air intake is slashed leading to an inferior performance. Hence, some user prefers to dismantle the filter so that a greater volume of air is able to pass through the cooling fan. Yet, dismantling the filter from the cooling fan results in the recurrence of the cottony dust accumulation problem and a shortening of working life.

### SUMMARY OF INVENTION

Accordingly, one object of the present invention is to provide a cooling fan system with dust-filtering function that can maintain a fairly constant performance and hence extend the overall working life of the fan.

To achieve these and other advantages and in accordance with the purpose of the invention, as embodied and broadly described herein, the invention provides a cooling fan system with dust-filtering function. The cooling fan system comprises a fan base, a fan module, a filter frame and a filtering unit. The fan base has an air inlet and an air outlet. The fan module is set up within the fan base and the filter frame is detachably attached to the fan base. The filtering unit is set up within the filter frame covering the air inlet of the fan base.

According to one embodiment of this invention, the filter frame is detachably attached to the fan base through a set of screws or a set of latches. In addition, the filter frame and the filtering unit can be manufactured as an integrative component. Moreover, the filter frame and the filtering unit can be manufactured using a metallic or a plastic material.

Since this invention has a detachable filter frame and filtering unit design, the filter frame and the filtering unit can be easily dismantled, cleaned and assembled to the fan base thereafter. Hence, the filtering unit can be repeatedly used to provide the fan module with a steady performance and an extended working life.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of the components of a cooling fan with dust-filtering function according to a first preferred embodiment of this invention.

FIG. 2 is a perspective view of the components of a cooling fan with dust-filtering function according to a second preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

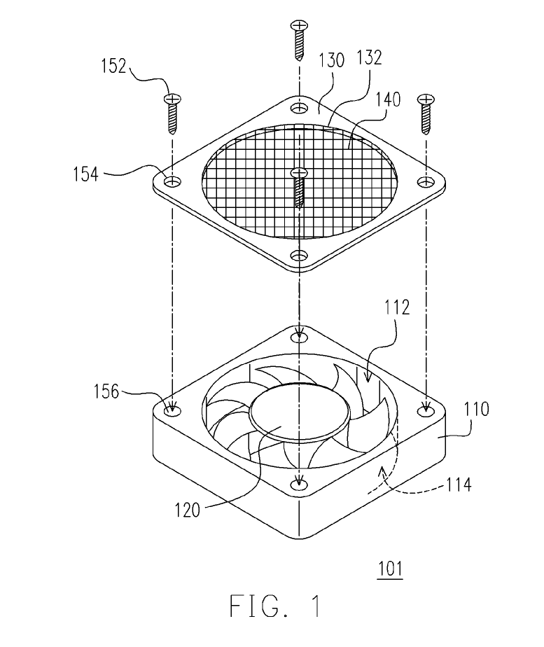

FIG. 1 is a perspective view of the components of a cooling fan with dust-filtering function according to a first preferred embodiment of this invention. The cooling fan 101 comprises a fan base 110, a fan module 120, a filter frame 130 and a filtering unit 140. The fan module 120 is airflow driver in the cooling fan 101. The fan module 120 is a device driven by electromagnetic forces. In general, the fan module 120 has electromagnets mounted on the rotor and the stator respectively. The rotor rotates and hence drives the fan blades of the fan module 120 to produce airflow. The fan module 120 is fastened onto the surface of an electronic device or a heat sink through the fan base 110.

As shown in FIG. 1, the fan base 110 is typically a rectangular frame having a hollow space in the middle for accommodating the fan module 120. When the cooling fan 101 is in operation, a stream of air blows in direction parallel to the axis of rotation of the fan module 120 creating an air inlet 112 and an air outlet 114 in the fan base 110. The streamline vector between the air inlet 112 and the air outlet 114 is almost parallel. However, if the cooling fan 101 provides a stream of air flowing at a non-parallel angle (or perpendicular) to the axis of rotation of the fan module 120, the streamline vector between the air inlet 112 and the air outlet 114 is also non-parallel (or mutually perpendicular).

Since impurities including cottony dust in the air easily absorb the lubricant on the axle (not shown) of the fan module 120, working life of the fan module 120 can be compromised. To extend the working life, the cooling fan 101 furthermore comprises a filter frame 130 and a filtering unit 140. The filter frame 130 is detachably attached to the fan base 110 through its peripheral section. The filtering unit 140 is set up in the middle of the filter frame 130 such that the outer edges of the filtering unit 140 is buried inside the outer edge of the opening 132 in the filter frame 130. Hence, the filtering unit 140 is positioned right over the air inlet 112 of the fan base 110. With this setup, the filtering unit 140 can filter away most cottony impurities before going to the fan module 120. With a reduction in cottony contaminants from the air, the accumulation of cottony dust on the axle of the fan module 120 during operation is greatly minimized. In other words, the working life of the fan module 120 is increased.

As shown in FIG. 1, the filter frame 130 is assembled to the fan base 110 by passing a few screws 152 through the holes 154 in the filtering unit 140 and tightening the screws 152 to the threaded holes 156 in the fan base 110. However, the filter frame 130 and the fan base 110 can be engaged together is another way such as through a series of latches.

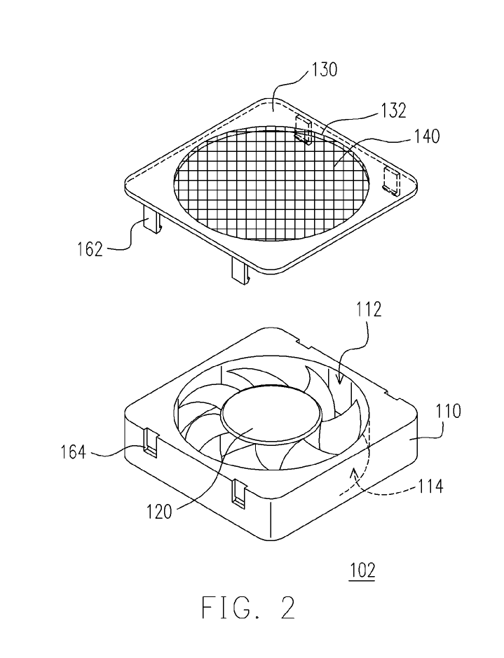

FIG. 2 is a perspective view of the components of a cooling fan with dust-filtering function according to a second preferred embodiment of this invention. As shown in FIG. 2, the filter frame 130 has a few latching hooks 162 attached to its edge for engaging with corresponding latching grooves 164 on the fan base 110 so that the filter frame 130 is detachable. Note that the positioning of the latching hook 162 on the filter frame 130 and the latching groove 164 on the fan base 110 can be interchanged. Although the detachable filter frame is engaged to the fan base through screws or latches, this is by no means the only ways to fasten the two together. Other ways of assembling and detaching the filter frame and the fan base should also be included in the scope of this invention.

The filter frame 130 and the filtering unit 140 in FIG. 1 can be fabricated individually before combining together or they can be manufactured together as an integrative unit. If the integrative filter frame and filtering unit is manufactured using a metallic material, mechanical strength of the filtering unit 140 will be improved. Thus, external forces are less likely to bend the filtering unit 140 and interfere with the fan axle and the cooling fan 101 can have a larger heat-dissipating surface. On the other hand, if the integrative filter frame and filtering unit is manufactured using a plastic material, problems caused by the oxidation during a cleaning operation is eliminated. In addition, a plastic integrative filter frame and filtering unit is cheaper to produce.

In summary, this invention utilizes a detachable method (for example, screws or latches) to attach a filter frame to a fan base so that a filtering unit completely covers the air inlet of the fan base. The filtering unit filters cottony impurities in the air so that fewer impurities are attracted to the axle of the cooling fan. Note that the detachable filter frame and filtering unit can be dismantled for cleaning when too much cottony impurities have been accumulated. In this way, the filter frame and the filtering unit can be repeatedly cleaned to provide a constant cooling capacity and an extended working life for the cooling fan.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A cooling fan with dust-filtering function, at least comprising:
a fan base with an air inlet and an air outlet;
a fan module set up within the fan base;
a filter frame detachably connected on the fan base; and
a filtering unit set up within the filter frame covering the air inlet of the fan base.

2. The cooling fan of claim 1, wherein the filter frame is detachably connected to the fan base by using a set of screws.

3. The cooling fan of claim 1, wherein the filter frame is detachably attached to the fan base by using a set of latches.

4. The cooling fan of claim 1, wherein the filter frame and the filtering unit are manufactured as an integrative unit.

5. The cooling fan of claim 1, wherein material constituting the filter frame is selected from a group consisting of metal and plastic.

6. The cooling fan of claim 1, wherein material constituting the filtering unit is selected from a group consisting of metal and plastic.

7. The cooling fan of claim 1, wherein the air outlet lies in a direction parallel to the axis of rotation of the fan module.

8. The cooling fan of claim 1, wherein the air outlet lies in a direction forming an angle with the axis of rotation of the fan module.

9. The cooling fan of claim 1, wherein the air outlet lies in a direction perpendicular to the axis of rotation of the fan module.
